(19) United States
(12) Patent Application Publication
(10) Pub. No.: US 2020/0357083 A1
(43) Pub. Date: Nov. 12, 2020

(54) COMPUTER-ASSISTED QUALITY CONTROL FOR COMMERCIAL KITCHEN

(71) Applicant: PERFECT COMPANY, Vancouver, WA (US)

(72) Inventor: Michael W. WALLACE, Vancouver, WA (US)

(73) Assignee: PERFECT COMPANY, Vancouver, WA (US)

(21) Appl. No.: 16/409,116

(22) Filed: May 10, 2019

(51) Int. Cl. G06Q 50/12; G06N 20/00; G06Q 10/06; G06Q 10/08

(52) U.S. Cl. CPC G06Q 50/12; G06Q 10/0875; G06Q 10/06316; G06N 20/00

(57) ABSTRACT

Systems and processes are described for improved management and operation of a commercial kitchen, for example, in a quick-serve restaurant. A communication hub may interconnect a production client comprising a digital device arranged to execute a production application; a preparation/cook client comprising a digital device arranged to execute an ingredient preparation application; and one or more connected kitchen appliances. A broker (hub) provides communications among the production client, the preparation client, the connected kitchen appliance and an orchestrator application. A database may be coupled to the orchestrator for storing a set of prescribed workflows and ingredients parameters for ingredients to make menu items. In an embodiment, an orchestrator client is configured to select and execute one or more of the workflows responsive to inputs received via the broker to manage preparation and holding of the ingredients to maintain menu item quality and food safety compliant with the corresponding ingredient parameters.

### RELATED CASE

None; this is an original application.

### COPYRIGHT NOTICE

© 2018-2019 PERFECT COMPANY. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This application pertains to methods, systems and software to realize computer-assisted workflow management to enforce quality control and food safety in a commercial kitchen or quick-service restaurant. Disclosed embodiments also support inventory control and reporting across multiple stores.

### BACKGROUND

In order for a commercial kitchen to succeed, it must deliver an appealing product to its customers, and do so consistently and in a timely manner Many restaurants, especially Quick-Service Restaurants (QSRs), have established training courses that familiarize staff with products, policies, techniques, and recipes that improve employees' ability to consistently and accurately reproduce the company's offerings. Restaurants thus spend large amounts of time and money training and retraining its employees. Restaurants have a particularly high employment turnover rate which can exacerbate costs.

Customers desire both consistency and variety from restaurants. There has been a tension, especially in the QSR market, between offering new products and perfecting a smaller menu. It is presently disclosed that limitations on human memory, attention, and the need for employee training limits the numbers and varieties of recipes that a restaurant can offer. Increased errors and lower consistency may also occur when too many items are simultaneously on offer. It is a benefit of some embodiments disclosed herein to avoid or reduce the need for employees to learn recipes in advance of launch. The need also remains to enforce quality control and food safety in a commercial kitchen or quick-service restaurant without slowing down the production process.

### SUMMARY OF THE PRESENT DISCLOSURE

The following is a summary of the present disclosure to provide a basic understanding of some features and context. This summary is not intended to identify key or critical elements of the disclosure or to delineate the scope of the disclosure. Its sole purpose is to present some concepts of the present disclosure in simplified form as a prelude to a more detailed description that is presented later.

The shortcomings of the prior art and the needs outlined above are addressed by the present disclosure. In one embodiment, a system may comprise a production client which may be implemented as a digital device arranged to execute a production application, the production client located in a production area in a commercial kitchen and having a first interactive user interface. The system further includes a preparation/cook client comprising a digital device arranged to execute an ingredient preparation application, located in a preparation area of the kitchen and having a second interactive user interface. The commercial kitchen may have one or more connected kitchen appliances, meaning an appliance arranged for electronic communication with a digital device or process to send and receive digital data. The connected equipment may be a node of the internet-of-things or IOT evolving technologies.

An example system further comprises an orchestrator client which may be a digital device arranged to execute an orchestrator application; a broker (or hub) arranged to provide communications among the production client, the preparation client, the connected kitchen appliance(s), and the orchestrator client. A database or other memory resource may be coupled to the orchestrator (locally or remotely) for storing a set of prescribed workflows and ingredients parameters for ingredients that may be used in a production area to make menu items. The orchestrator application should be configured to select and execute one or more of the stored workflows responsive to inputs received via the broker so as to manage the preparation and holding of the ingredients to maintain quality and safety of the ingredients during each ingredient's corresponding lifetime in accordance with the corresponding ingredient parameters. Preferably, the orchestrator application is arranged to dynamically maintain in memory indicia of the corresponding location, state and current timer value of every ingredient currently in use in the kitchen production area.

In some use cases, the connected kitchen appliance may be cooking equipment, and the cooking equipment is arranged to transmit state data to the broker. In some embodiments, a connected kitchen appliance state machine application may be provisioned, coupled to the broker and arranged to maintain a virtual state machine responsive to the data transmitted by the connected kitchen appliance.

Some of the embodiments provide solutions to monitor the quality of food, such as hold time (i.e, the time since fried or rethermalized), temperature, expiration time, etc. As a result, while it is observed and presently disclosed that carryover is too infrequent, and food waste is too common—in part because of the need to include large food safety margins in a traditional workflow, some of the embodiments described herein may be used to substantially increase carryover volumes and decrease waste.

### BRIEF DESCRIPTION OF THE DRAWINGS

To enable the reader to realize one or more of the above-recited and other advantages and features of the present disclosure, a more particular description follows by reference to specific embodiments thereof which are illustrated in the appended drawings. Understanding that these drawings depict only typical embodiments of the disclosure and are not therefore to be considered limiting of its scope, the present disclosure will be described and explained with additional specificity and detail through the use of the accompanying drawings in which:

FIG. 1A is a simplified overview diagram of an example of a computer-assisted quality control and management system for a commercial kitchen.

FIG. 1B is a simplified conceptual diagram of an example of a system for automated commercial kitchen workflow and management operations.

FIG. 2 a simplified diagram of an example of a computer-implemented control system architecture for a commercial kitchen.

FIG. 3 is a simplified diagram of an example of data flow in a commercial kitchen with some unconnected equipment and some connected equipment.

FIG. 4 is a simplified flow diagram of a general ingredient workflow.

FIG. 5 is a simplified flow diagram of a non-limiting example of an ingredient request workflow as it might be processed in some embodiments.

FIG. 6 is an example of a cook station (Rethermalizer/fryer) client app main screen display.

FIG. 7 is another example of a prep station (client) landing screen.

FIG. 8 is an illustration of an example of a production line station home screen display.

FIG. 9A illustrates an example of a workflow for managing a refried beans ingredient.

FIG. 9B is a continuation of FIG. 9A.

FIG. 10 is an example of an end-of-day carry over screen display.

### DETAILED DESCRIPTION OF PREFERRED EMBODIMENTS

In some embodiments, an individual store or other production facility may have a data hub to manage the local network of connected devices, equipment, and user applications, and/or to broker any information being communicated among some or all of the devices. A broker may, in some embodiments, comprise software and hardware configured to provide the required management and/or information exchange functionality. In some embodiments, the broker may act as a bridge between local devices and one or more remote servers, applications, networks, cloud services, other remote devices, sites, and/or services. More detail about the broker and a preferred client architecture is provided below.

### Overview of Smart Commercial Kitchen

In certain embodiments, multiple devices in a kitchen or production facility may include sensors (e.g. scales, switches, vibration sensors, pressure sensors, movement sensors, photosensors, thermometers, chronometers, etc.). Sensor-enabled devices may store data locally and/or may transmit them to one or more local and/or remote storage devices, such as the cloud. For example, in some embodiments a commercial kitchen may have a fryer, grill, rethermalizer, microwave, range, blender, food processor, mixer, oven, fridge and/or freezer, holding drawer, soft serve or milkshake machines, hot cabinet, and/or production lines, any of which may be fitted with scales or other sensors.

In some embodiments, sensors may be used to detect the position of or identify equipment. For example, a scale may use the weight of an empty vessel to determine which kind of vessel is in place. The identity of a vessel may be used to filter or limit options available to a user through the interface and/or to indicate an error when a user should not be using the specific item. In some embodiments, sensors other than scales are used for the detection and identification of equipment, ingredients, and/or other physical items.

In some embodiments, multiple connected devices in a commercial kitchen or production facility may have one or more sensors, which log timestamped information. The connected devices may operate in a peer-to-peer network and/or may be centrally controlled by a local controller or broker, a networked controller or broker, and/or a cloud and/or distributed system.

Some embodiments allow the retrofitting of legacy and/or conventional equipment with sensors and/or connectivity in order to realize some or all of the benefits of the present disclosure. Modules containing sensors and or network communication hardware may be added to existing equipment in order to provide additional data and functionality, for example, in a user application described herein.

### Display and Visualization in Smart Commercial Kitchen

Some embodiments of a user application may provide virtual representations of equipment and/or ingredients, or other materials and/or people. Virtual representations may include information regarding location, position, orientation, flavor, color, food type, ingredients, allergen content, temperature, history, shelf-life, food-handling guidelines, and/or other attributes. In some embodiments, use of the virtual representations may allow better management of food or materials, expiration times, and/or identification of a preferred order in which materials or ingredients should be used. Virtual representations may also contain data regarding the status of food or materials during execution of a recipe, cooking and/or manufacture. For example, some embodiments may allow management of food or materials where sensory data may not be available due to environmental conditions, space constraints, or other limitations within equipment. As an illustrative and non-limiting example, use of the user application may allow a user to identify which particular food item among a number of similar or identical items was added to a freezer or hot cabinet earliest and thus, according to a defined protocol, which should be cooked or served next.

Virtual representations of equipment may, in some embodiments, allow for the acquisition, analysis, use, and/or presentation of real-time data regarding each machine, including its cleaning schedule, calibration status, maintenance schedule, location, orientation, position, temperature, feature set, historical usage, repair history, or other relevant attributes. Interfaces may leverage virtual representations to show real-time data on equipment-specific services, performance, cleaning schedules, and maintenance, for example. Equipment manufacturers may also have access to the virtual equipment for updates, general data, or maintenance needs.

In some embodiments, user applications may display a graphical depiction of virtual representations of equipment and/or ingredients. As a non-limiting example, a virtual hot cabinet may be displayed as an illustration of a cabinet with representations of ingredients being held. A virtual hot cabinet may display temperatures, times held, and/or other attributes about the cabinet itself or the items within.

Some embodiments may store, as part of a virtual representation of each ingredient, where the food has been stored and/or when the food will expire based on current or predicted conditions. In some embodiments, user applications may use this information to provide enhanced instruction to employees or automated equipment. As a non-limiting example, such a system may indicate which package of chicken in a freezer should be cooked next and/or which fryer oil should be used to cook a batch of fries.

### Additional Feature—AI and Automation

In some embodiments, the user application can incorporate machine learning, statistical, heuristic and/or artificial intelligence (AI) functionality. Automated equipment can utilize AI for more accurate data and information and/or to improve efficiency. As non-limiting examples, equipment using AI or similar technology may track the quantity of ingredients in a holding drawer, when they are scheduled to be removed (e.g. for food safety or freshness reasons), and/or to perform processes with automated equipment without human intervention. For example, in some embodiments, automated equipment may be configured to move food from freezer into a rethermalizer precisely when re-heating is deemed necessary, e.g. by demand or recorded expiration times. In some embodiments, automated equipment may be used to track cook times and/or analyze sensor data to execute recipe steps in an automated manner (e.g. automated burger flipping, etc.). In some embodiments, automation using the user application can lower labor expense and improve quality and efficiency.

In some embodiments, a connection may be made from a user application directly to a POS system in the retail section of the facility (e.g. “front of house”) for a fully-connected store environment that can tailor what is being cooked based on varying consumer habits. In some embodiments, algorithms given the benefit of present demand and/or historical order data may be able to decrease food waste, and/or more accurately prepare for user demand Where recipe steps have a long lead time (e.g. rethermalizing a dense frozen ingredient) more accurate predictions of demand may be able to dramatically improve efficiency and/or decrease waste.

In some embodiments, recipes are generated in a location, then distributed to one or more remote production facilities. Where ambient conditions are different (e.g. temperature, humidity, elevation, ambient pressure, nature of available ingredients, market regulations, price of specific ingredients, etc.), and/or where market tastes dictate, recipes may be adapted locally either automatically or through user intervention to improve consistency, quality, and/or marketability. In some embodiments, customized recipes can be distributed (e.g. based on predictions, models, heuristics, and or recipe testing) for each location to guarantee consistency at multiple locations (e.g. nationally or globally).

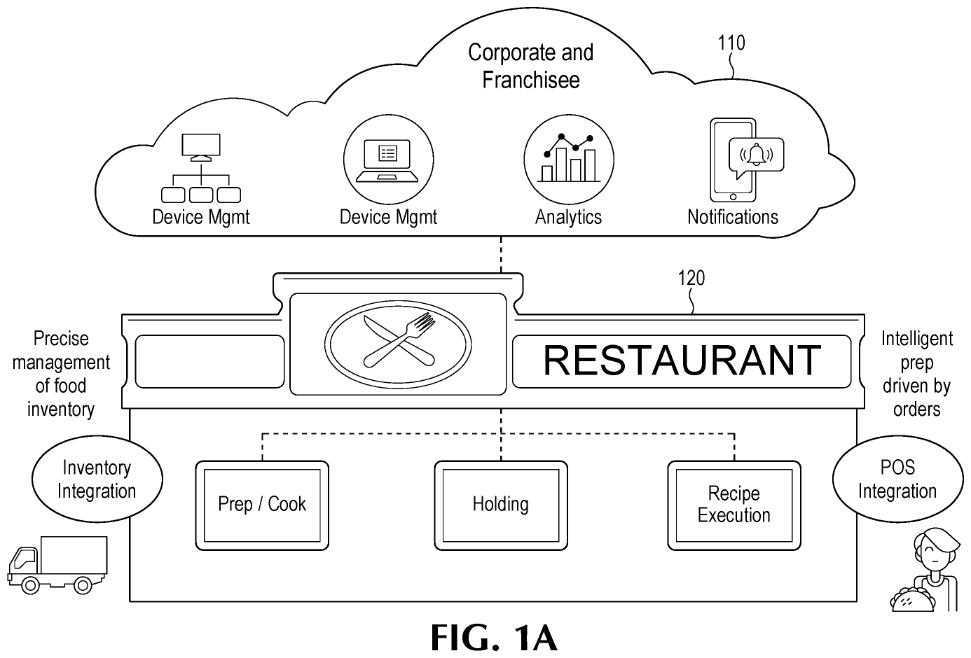

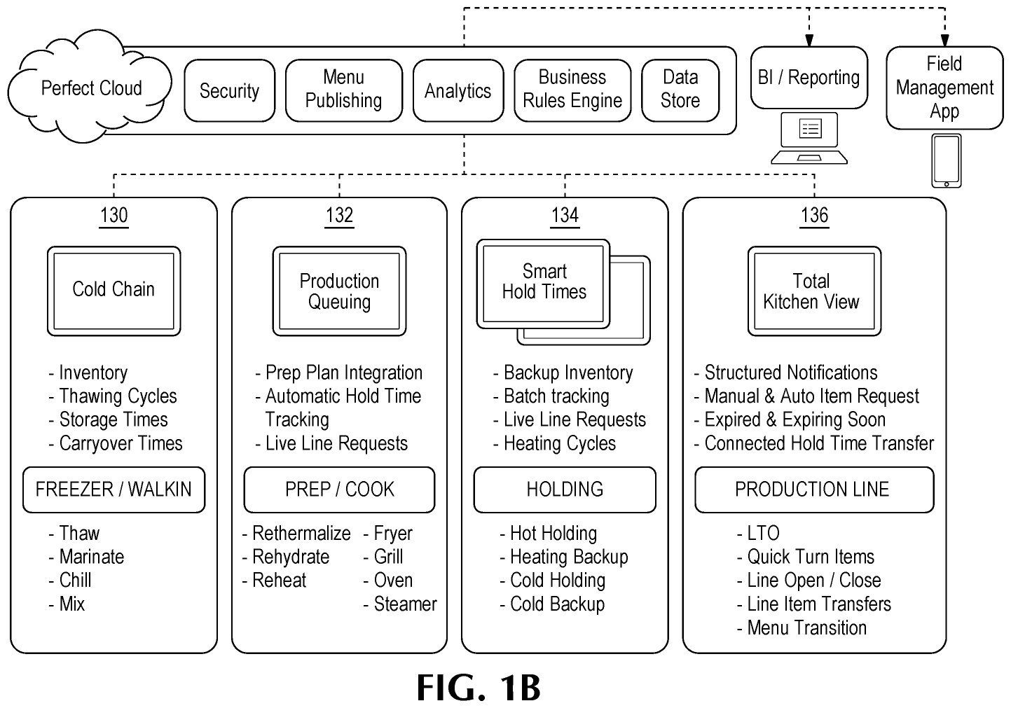

FIG. 1A is a simplified overview diagram of an example of a system for computer-assisted commercial kitchen workflow. In the illustrated example, various equipment and processes can be provisioned in the cloud 110 shown at the top of the drawing. In the case of a franchised business, for example, a quick-serve restaurant 120, cloud-based resources can provide services at both the corporate and franchisee level. These services may include device management, menu management, analytics and notifications. For example, this cloud-based architecture enables the corporate franchisor to collect per franchisee or even individual store data in real time.

This arrangement also enables the franchisor to “push out” new menu items or limited time special offers almost instantaneously. The details of new items (such as preparation and production workflows) are downloaded to the stores, for example, via a communications hub installed in each store as detailed below. See the dashed lines connecting the cloud to prep/cook, holding (production line) and recipe execution applications. An orchestrator application (not shown here but described below) can store the information in a local database, and utilize it as described herein to bring the new item into production with minimal employee training. The diagram also shows optional inventory integration and POS integration in an individual store location.

FIG. 1B is a simplified conceptual diagram of an example of a system for automated commercial kitchen control and workflow. In this example, various application programs and screen displays are shown. Example applications may include a Cold Chain app 130 to manage ingredients that are received at the restaurant in a frozen state; Production Queuing app 132, Smart Hold Times 134, and Total Kitchen View app 136, described in more detail below. Representative functions and operations are listed below each application. In an embodiment, applications are shown providing corresponding screen display for four locations in a representative commercial kitchen, namely, Freezer/Walkin, Prep/Cook Area, Holding, and Production Line. A particular implementation may have more than one of any or all of these applications/displays. For example, a kitchen may have two prep/cook areas, and or three production lines. The dashed lines indicate that these applications preferably are networked together for communications, using any convenient networking technology, wired or wireless. Communications are described in a preferred embodiment in more detail below.

FIG. 1B also shows the kitchen applications coupled to a computing cloud where other functionality may be implemented. Examples shown in the cloud include security, menu publishing, analytics, business rules engine and data store. These functions are merely illustrative and not limiting. The cloud functions may implement and may integrate or aggregate functions across multiple kitchens, for example corresponding to a common owner or operating region of a franchise. Further, the cloud computing operations may aggregate functions, analysis and reporting across multiple regions—even covering a major franchise with thousands of franchisee locations. Because of the direct connections as illustrated, high-level overview data can be generated, along with “drill-down” to very granular data as needed. All of this can be done in essentially real time using the described system. Further, the diagram shows a field management mobile app which can communicate with the cloud and provide any and all data of interest to a manger in the field.

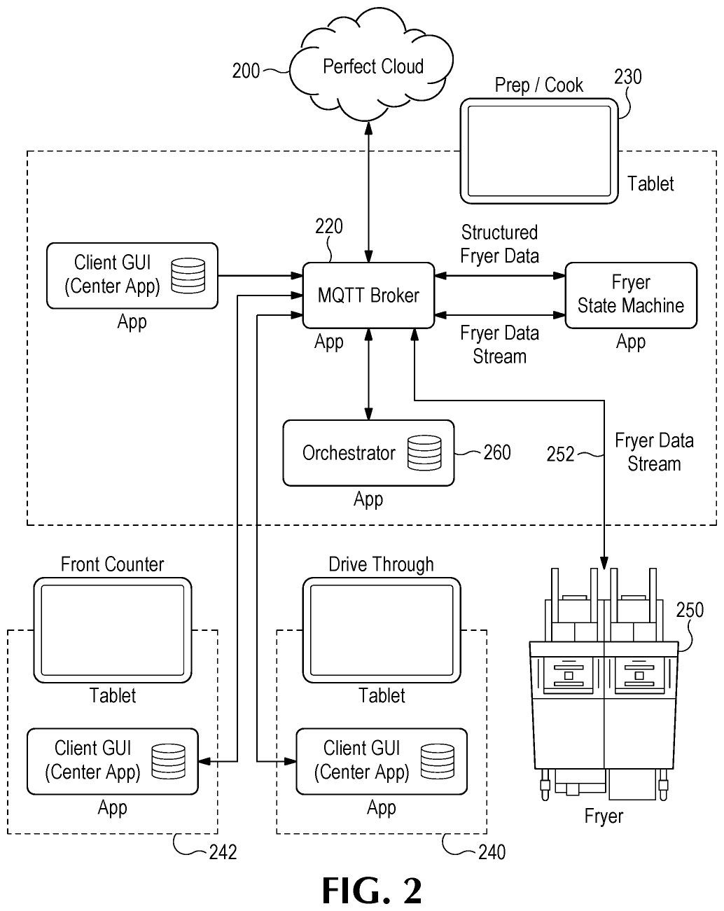

FIG. 2 a simplified diagram of an example of a computer-implemented control system client architecture for a commercial kitchen. This system may be coupled to a cloud 200 (see FIG. 1) or operate autonomously. At the center, graphically and functionally speaking, is a hub or broker 220 (labeled “MQTT Broker” per one example). The broker acts as a communication hub linking at least one prep/cook area client 230, a production client 240 and an orchestrator client 260. There may be additional production clients 242. The prep/cook a preparation/cook client 230 may comprise a digital device, for example, a laptop or tablet computer, arranged to execute an ingredient preparation application. The prep/cook client 230 should be located in a preparation or cooking area of the kitchen, so that the display screen is visible to user employees during operations. and having a second interactive user interface;

The orchestrator client 260 may comprise a digital device arranged to execute an orchestrator application. In another embodiment, the orchestrator application may be run on the device 230 running the prep/cook application. The broker or hub 220 also may be a software process running on the device 230, or on another device. In any event, the preparation/cook client 230 and the production client 240 and the orchestrator 260 are coupled or networked to the hub for communications. In one preferred embodiment, the broker comprises an MQTT server; and each of the aforementioned clients implements an MQTT client for communications with the MQTT server.

In some embodiments, the use of a data broker improves hardware and/or software agnosticism and/or interoperability. In some embodiments, the broker functionally includes security services to improve overall security and/or reduce the attack surface. In some embodiments, the broker can improve efficiency by removing a need for each connected device or application to communicate with a remote site or distributed network.

In some embodiments, a broker can coordinate and/or manage the behavior and/or data acquisition from some or all of the connected devices, equipment, and/or applications. For example, in some embodiments, the broker may ingest and parse data collected and sent by connected kitchen equipment, and translate it into relevant action items for the store (e.g. steps needed to be taken upon the event of the imminent completion of a recipe, or providing instructions to handle a situation in which a particular ingredient is running low and/or is predicted to run low within a certain window of time). In some embodiments, the processing and/or generation of action items may take place within the internal broker, at a remote site or distributed network of sites, at individual machines, or in any combination thereof.

Use of a local broker, in some embodiments, may provide enhanced stability compared to a cloud-centric model. In the case of an external connection issue, a local broker may be able keep systems running according to a locally-stored workflow, routine, or other procedure, using only the local connectivity.

In some embodiments, telemetry and application data collected and/or parsed by a broker can be sent to a remote facility for storage, further data ingestion, and/or analytics that may be used for the evaluation of recipes, creation of new recipes, modification or adjustment of store workflows, monitoring of equipment life cycles and/or performance, etc. Updates generated may be sent back to an individual broker at a specific store or production site to allow a recipe to be distributed among many locations, and/or evaluated through the captured data.

Data Translation from Connected Kitchen Device

In some embodiments, raw data from a machine or device is evaluated and converted into business events (business events may include, e.g., the occurrence of a full cleaning cycle, the initiation of a frying cycle, fryer oil temperature variations induced by food addition or removal, cooking oil quality variations, etc.). In some embodiments, the business events will include timestamps, identifiers related to specific items of equipment, identifiers related to ingredients present or relevant to the business event, and/or other sensor or relevant data. The process of converting data into business events allows meaningful analysis and improves signal-to-noise ratios in later statistical analyses. As a non-limiting example, a parser considering business events for a particular oven might choose to disregard temperature measurements overnight, or at other times when the equipment is inactive, as the temperature of an oven that is not in use is not meaningful from a business standpoint. In some embodiments, collecting and translating individual data in an understandable pattern allows a reconstruction of each business event and efficient evaluation of the sensor data relevant to each event, as well as a presentation of meaningful and actionable information to a user.

In some embodiments, a stream of business events (e.g. the collected timeline of events for a single piece of equipment) may be translated and compared to other translated streams for the same equipment, and/or analyzed for patterns and/or outliers which may affect food quality or equipment life. In some embodiments such translation can be performed continuously and/or automatically to provide instructions for intervention, and/or, where enabled by equipment, to automatically intervene.

As a non-limiting example, in a deep fryer cleaning process, there may be automated steps and manual steps. If, for example, a stream of business events indicates that a filter pump was turned off for manual cleaning at a first time, and that the filter pump was then turned on a few seconds later, this information could alert an auditing person or application to the likelihood that the manual cleaning was not performed or performed in unsatisfactory way. Similarly, organization of the disparate data into meaningful events can improve the ability to understand the health, efficiency, and operation of a kitchen or production lab in general, and to pinpoint areas needing correction, repair, intervention, etc. To illustrate, FIG. 2 shows a fryer 250 communicating a fryer data stream 252 to the broker 220.

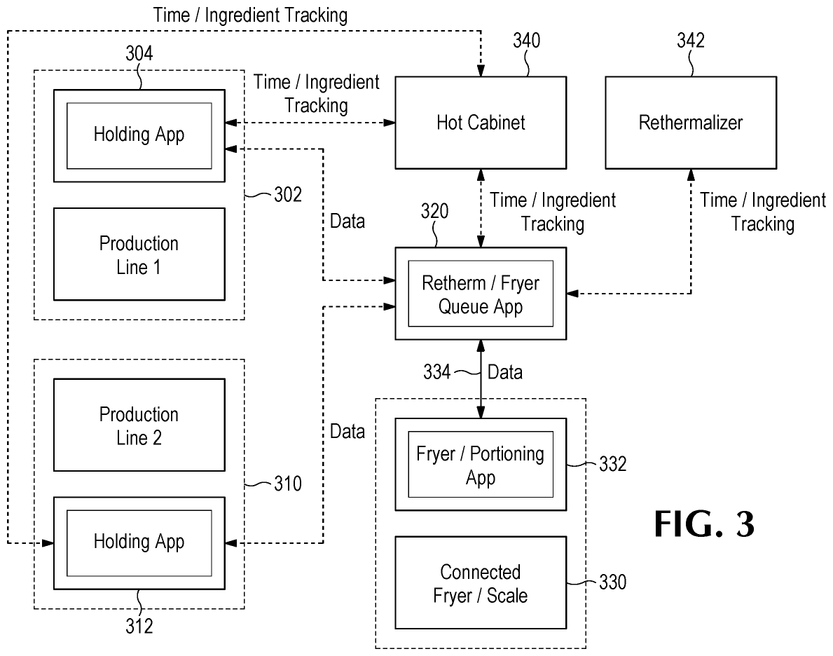

FIG. 3 is a simplified diagram of an example of data flow in a commercial kitchen with some unconnected equipment that the client apps still track manually without a direct data connection. This may be done, as detailed below, using interactive user interfaces (for example, touchscreen devices) in connection with cook/prep clients and production clients. This embodiment illustrates a production line 302 with an associated production/holding app executable on a processor device 304 having a display screen. Similarly, there may be a second production line 310 (or more) with an associated device 312. The applications are not necessarily (or not only) executable on the associated device. In one alternative architecture, several or all applications may be run on a central processing resource, and “bare” display screens located in the appropriate physical locations. Continuing the illustrated example, a retherm/fryer queue app 320 is arranged for data communications with the production line (holding app 304) and the second production line 312. In some embodiments, the data communications may be realized by a hub or broker as described above. In some embodiments, a connected fryer 330 or other connected kitchen equipment may include or be coupled to a corresponding app, say fryer app 332. The fryer or other equipment app 332 communicates data with the retherm/fryer queue app 320 via path 334. The fryer may have an integral scale for managing portion size. With this data connection, the retherm/fryer queue app 320 can track and display fryer status in real time. In more detail, the fryer 330 may report what ingredient batch is cooking in which vat, what is draining, status of timers, what is ready, etc. It can also maintain maintenance data and trigger alerts for maintenance issues. As explained with regard to FIGS. 1 and 2, any and all such data can be uploaded to a store manager display, as well to the cloud for regional and corporate data collection and analysis. As one example, the corporate user can see usage of fryers across the franchise, and maintenance issues.

Referring again to FIG. 3, the holding (production) app may track time and ingredients for those ingredients located in a hot cabinet 340 using the processes described below, even in the absence of a direct data connection. For example, when a user input confirms moving a batch of an ingredient from the rethermalizer equipment 342 to the hot cabinet 340, the retherm/fryer queue and the hot cabinet data are updated accordingly. As explained, in the future, as more equipment becomes connected in more ways, the disclosed system can be easily adapted to take advantage of those connections. For example, referring back to FIG. 2, additional connected equipment (not shown) may be added and arranged to communicate data to and from the broker 220 for interacting with the corresponding clients such as the prep/cook client.

As described herein, multiple devices in a commercial kitchen may contain sensors which recognize and transmit the condition and/or status of equipment, ingredients, or products, etc. (conditions may include, for example, weight, temperature, ON/OFF, cleaning, heating, etc.), to relevant devices, broker systems and interfaces, and/or local or external storage, such as the cloud. The status or condition may be translated from raw data. Simultaneously in the storage devices, several workflows are stored.

### Workflows

Each workflow may represent a particular process performed in a smart commercial kitchen, or a recipe of each menu item. For example, there may be workflows managing preparation of an ingredient (beef, bean, fries, etc.), preparation of a recipe (i.e. nachos, salads, smoothies, soft-serve, etc.), the expiration of ingredients and/or when to carryover, rethermalize, or discard, and/or how to clean equipment, etc. Some embodiments may also include a processor to control or organize multiple workflows based on the sensed input from each kitchen device, or provide instructions from a touch panel. In each step of each workflow, if an error is recognized via the attached sensors, an alarm may be sent to each relevant kitchen device or display in order for the employee to easily locate and understand the status, and react as necessary. As such, the operation within a smart commercial kitchen can become more efficient and sophisticated.

As a non-limiting example, the fryer may contain a temperature sensor and weight scale. In the case where a customer orders a certain amount of fries, the first step (based on the workflow) may be to check if enough fries are already ready-to-use, and if not, initiate a fry preparation workflow. Once the correct amount of fries needed for preparation is determined, the temperature of the fryer may be checked to ensure that the oil remains at an optimal temperature and quality level for the current batch. The determined amount of fries may then be displayed on or near the corresponding kitchen device(s), prompting the employee to put the displayed amount into the fryer (once temperature and oil quality is confirmed). The fryer may then sense the how many fries have actually been put into the fryer (i.e. based on the batch weight), and may display the information on the kitchen device(s). The fryer sensor may continue to track the temperature throughout cooking, and update the employee (preferably via a user interface display) regarding the precise time to pull them from the fryer. The timing may vary based on the types of ingredients and products, which may be previously determined in view of which workflow is initiated. The system may display a warning in advance of the time to remove the fries from the fryer.

In some embodiments, when multiple workflows are initiated for operation simultaneously, the most efficient prioritized operation may be determined. In a non-limiting example, if there is an order for both fries and a side salad, and the fryer indicates that the oil temperature is low, the workflow (displayed on the kitchen device) may suggest preparing the side salad while the oil gets back up to temperature.

In some embodiments, not all kitchen devices or equipment may be connected to a sensor or the user interface. In another non-limiting example, if the fryer is not connected, or becomes disconnected, the system may identify that it is not connected because there is no data input from the fryer, and may automatically initiate a “non-connected fryer workflow” instead. If such a workflow is initiated, the employee may also select which ingredients are needed manually on the device in order to see the preferred fry times in a standard situation related to that ingredient. Connected and non-connected fryers, or other equipment, may be mixed within a single restaurant.

In some embodiments, the recipe and workflow models can be expanded to other commercial functions or processes. For example, implementing recipe and workflow methods with respect to the functions and/or processes of a commercial kitchen may allow for a single data-model across all areas of the business.

As a non-limiting example, in some embodiments, processes such as: cooking, ordering, preparation, equipment maintenance, logistics, procurement, cleaning, training, employee management, retail, customer feedback, facilities maintenance, and other processes may be controlled or organized in whole or in part by a queue-based, step-by-step workflow. In some embodiments, the collection of apparently disparate processes allows for synergistic benefits. As a non-limiting example, an organization, according to some embodiments, may elect to use a single controller across all production area (“back-of-house”) equipment as part of the production line, and asset management through ingredient tracking from delivery, through storage, to final production.

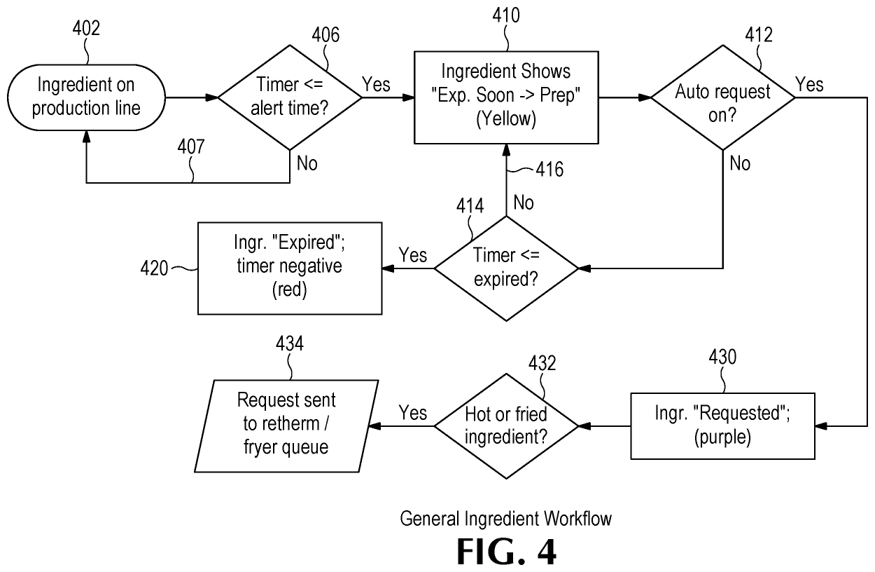

FIG. 4 is a simplified flow diagram of a general ingredient workflow. Here, an ingredient is on a production line, begin block 402. Decision 406 monitors a corresponding timer to see if the value is below the assigned alert time. Alerts may be triggered, for example, when a timer such as a hold time will expire soon, or when a cook time has expired. Preferably, certain ingredients with long prep times may have an audible alert attached both their “Expiring Soon” and “Expired” notifications in the prep/cook client app. The notification tile may flash off and on.

As noted above, ingredient parameters preferably are stored in a database accessible to at least the orchestrator application. As a non-limiting example, ingredient parameters may include ingredient name, translations of the ingredient name into one or more languages, category (e.g. hot, cold, fried, etc.), one or more subcategories (e.g. protein, rice & beans, sauces, dairy, sauces, produce), hold time (e.g. a countdown timer indicating how long an ingredient will be useable for health and/or freshness reasons, etc.), preparation time (e.g. amount of time it takes to prepare more of the ingredient), eligibility for carryover, time remaining before carryover will not be allowed, cook time (e.g. countdown timer for hot and fried ingredients indicating time left until heating/frying/rethermalizing/etc. will be complete), drain time (e.g. countdown timer, e.g. for fried ingredients, showing how long the ingredient needs to drain), cool time (e.g. countdown timer for fried ingredients showing cooling time remaining before the ingredients can be used), auto-request status (e.g. whether the ingredient will be automatically started once the preparation timer has expired), whether the ingredient is eligible to be stored in a hot cabinet.

TABLE 1
Example Ingredient Parameters

| | |
|---|---|
| Ingredient Name: | Text; appears at top of ingredient icon or tile. |
| Category: | Hot, Cold, or Fried. Determines what tab the ingredient appears on. |
| Subcategory: | For hot and cold ingredients. Controls groupings on the hot and cold tabs. |
| Hot subcategories: | Protein, Rice & Beans, Sauces. |
| Cold subcategories: | Dairy, Guac & Salsa, Produce, Sauces. |
| Hold Time: | Countdown timer determining how long ingredient can be used once prepared. |
| Prep Time: | Amount of time it takes to prepare more of the ingredient. |
| Eligible for Carry Over: | Flag; can this item be carried over? |
| Carry Over Time: | Minimum hold timer remaining to permit carry over. |
| Cook Time: | Countdown timer for hot and fried ingredients showing time until |
| | frying/rethermalizing is complete. |
| Drain Time: | Countdown timer for fried ingredients showing how long the ingredient needs to |
| | drain. |
| Cool Time: | Countdown timer for certain fried ingredients showing how long they need to be |
| | cooled before use. |
| Auto-request flag: | Is this ingredient set to auto-request more when the hold timer reaches the prep |
| | time? |
| Auto-request time of day: | Is there a time of day range that this auto request is active? |
| Request more: | Where do requests go, fryer, rethermalizer, or none? |
| Hot Cabinet Eligible: | Flag; can this ingredient be stored in the hot cabinet? |
| In Hot Cabinet: | Is this ingredient currently in the hot cabinet? |
| Go Live Date/Time: | Used if an LTO (limited time offer) item. |
| LTO End Date: | Date LTO is no longer offered. |
| Fryer Recipe File: | For connected fryers. |
| Fryer Recipe: | Cook Time |
| | Shake Time #1 |
| | Shake Time #2 |
| | Drain Time |
| Cool Time Fryer portion weight: | if appropriate |
| Fryer portion weight dead band: | High & Low |
| Fryer Basket: | if appropriate |

Returning to FIG. 4, if the timer has not reached an alert time (decision 406 “N”), the process loops via path 407 to continue monitoring the timer. (“Monitoring” is used here broadly; it is not limited to periodic query, interrupts, or other implementations.) When the alert time is reached, the ingredient tile changes to show “Expiring soon Prep” or another indication to the effect, block 410. In a preferred embodiment this may appear in the prep/cook station client user interface. Next the workflow determines at decision 412 whether automatic request is on (enabled) for this ingredient. The may be reflected, for example, in the stored ingredient parameter files. If not, (N) proceed to decision 414 to determine if the timer is expired. If it has not expired, loop via path 416. If (when) the timer expires at decision 414 (here, auto request is not on), the ingredient state changes to “Expired,” block 420, and the display tile is updated accordingly. Preferably, different colors may be used on the tile displays to indicate different states. An “Expired” state preferably may have a red color on the display because of its importance and relative urgency.

Returning now to the decision 412, if the auto request flag is on (Y), the process changes the ingredient state to “Requested” at block 430 and proceeds to the hot or fried decision 432. If yes, the process sends the request to the retherm/fryer queue process 434 described in more detail as follows.

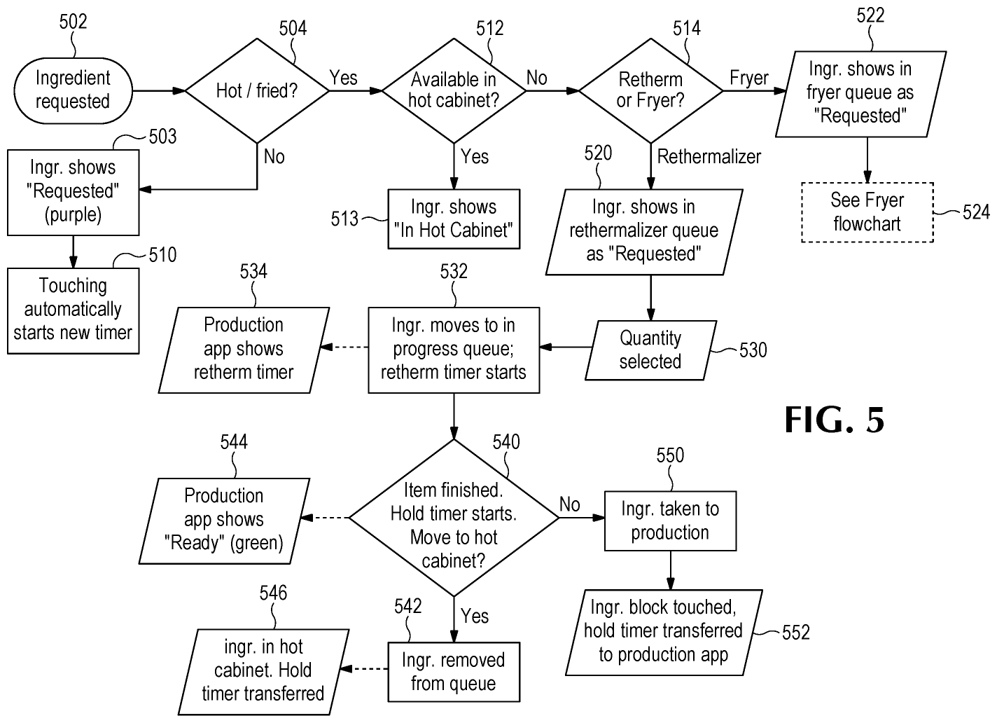

FIG. 5 is a simplified flow diagram of a non-limiting example of an ingredient request workflow as it might be processed in some embodiments. An ingredient is requested, block 502. More specifically, the request may be manual or automatic. It may be generated by a user input, for example, to the production client user interface. Or, it may be generated automatically by a workflow, for example, when the hold time is nearing expiration for an ingredient that has a significant preparation time. It is better to begin preparing a new batch of that ingredient ahead of the hold time expiration so that the supply on the production line does not run out.

Decision 504 tests whether the requested ingredient is a hot or fried ingredient. If not, the ingredient state is updated 506 to show “requested” and this may change the color of the corresponding display element (such as, but not limited to a tile) or part of it. This update will appear on any or all display screens where that ingredient is inspected. Since the item is not hot, a user may prepare a new batch simply by fetching the item from inventory, say a walk-in refrigerator. The user then taps the corresponding tile (or otherwise enters an input at a user interface) 510 to indicate a new batch is now in use. The system then starts (or resets) a hold timer for that new batch of the requested ingredient.

If the decision 504 indicates (yes) a hot or fried item, then decision 512 checks whether a batch of the requested item is available in the hot cabinet. If yes, the ingredient tile or a popup shows “in hot cabinet,” block 513 in the diagram. We use “tile” is this discussion to mean generally a visual indicator corresponding to an ingredient—it is not literally limited to a tile. The user may then “claim” the batch of ingredient from the hot cabinet—a process detailed later. This includes moving the batch physically from the hot cabinet to a production line and providing an input to the system to report the move. In turn, the system will accordingly update status and location data for that batch and start or adjust a timer if indicated. Hold time may just carry forward from the hot cabinet, or a new hold time may begin at the time of the move to the production line. These variables may be determined by the stored ingredient parameters.

If the decision 512 indicates (no)—the ingredient is not available in the HC, the next decision 514 determines whether the item is prepared (or “cooked”) by rethermalizer or by fryer. Preparation process may be indicated in the corresponding ingredient parameters maintained in a database as noted. If the answer is rethermalizer, then the requested ingredient is shown in the rethermalizer queue (on the cook/prep display) as “Requested,” indicated at block 520. If the answer is “Fryer,” then the requested ingredient is shown in the fryer queue (on the cook/prep display) as “Requested,” indicated at block 522. Then the fryer process will proceed, block 524.

Referring again to the rethermalizer queue block 520, the display will enable a user to select a quantify of the requested ingredient, block 530, and then the ingredient moves to an in-progress queue, and the rethermalizer timer starts, block 532. The production app display is updated, block 534, to show the rethermalizer timer. Preferably, it may count down, showing the time remaining until the rethermalization is done. When the item is finished (the retherm time completed), then a hold timer starts for that item automatically, block 540. The production client (app) updates the display to show the item is “Ready,” block 544. Preferably, the tile may change color.

The system may issue a notification to that effect, and query (for example, in a popup display) whether the item has been moved to the hot cabinet, block 540. Responsive to a user input in the affirmative, the location and status of the ingredient are updated accordingly, and it is removed from the queue display, block 542. The item is then indicated as located in the HC, and the hold timer is transferred, block 546. If the item is not moved to the hot cabinet, presumably it is moved to a production line, block 550. The user provides an input (for example, touch the ingredient block or tile on the user interface display) and the hold timer is transferred to the production client app, block 552.

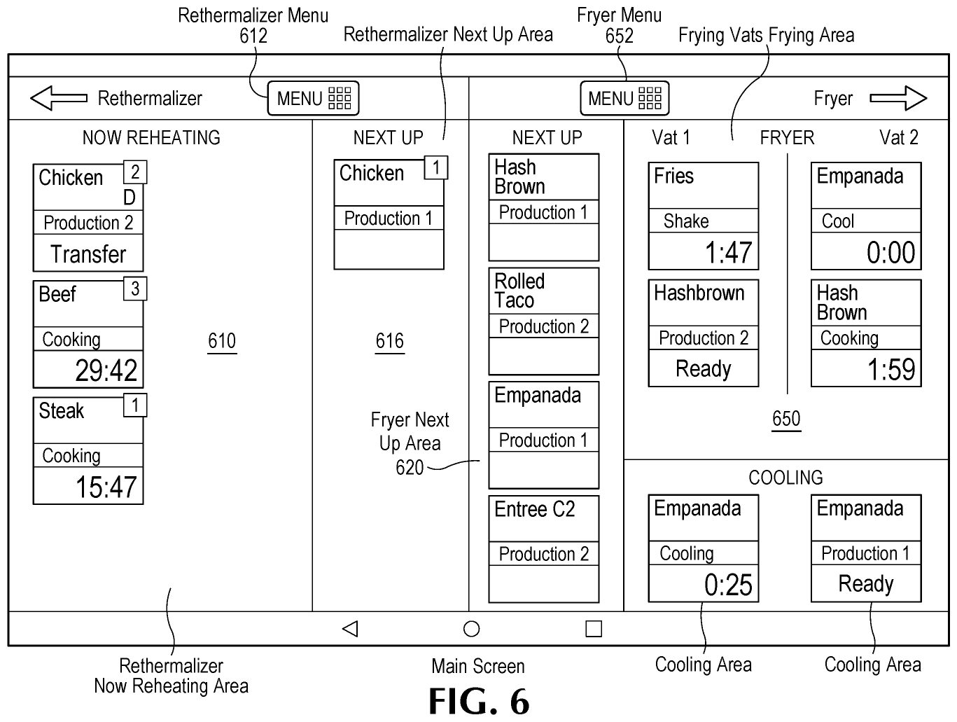

FIG. 6 is an example of a cook station (Rethermalizer/fryer) client app main screen display. In this example, the screen is divided into rethermalizer information 610 on the left side and fryer information 650 on the right. The Rethermalizer section of the app manages requests sent to the Rethermalizer from the Production Line app and tracks what ingredients are in the Rethermalizer and their hold times. It allows starting a Rethermalizer job manually by picking an ingredient and quantity from the menu. Near the top, on the retherm side, is the retherm menu button 612 that can be used to display retherm ingredient items, and a pop-up to enable a user to choose a quantify, for example, bags of beef. This can be used to manually enter a request for the beef. After selecting an ingredient and its quantity, the ingredient appears in the “Next Up” or Queue area and the menu is closed.

The request queue in one embodiment contains all requests for Rethermalized ingredients sent from the Production Line app or from Rethermalizer Menu. They appear top to bottom, in the order received. If there are more requests than fit on the screen the queue can be scrolled, allowing the operator to pick jobs out of order if necessary. Ingredient tiles in the queue may have a banner showing which production line they originated from; however if it originated from Rethermalizer menu, there is no banner. These particulars are currently preferred but not critical. Touching an ingredient tile moves the requested ingredient to the In Progress area. This queue is a stack—new ingredients appear at the bottom and ingredients move up as other ingredients are removed. Similarly, near the top, on the fryer side, is a fryer menu button 652 that can be used to display fryer-prepped ingredient items, and a pop-up to enable a user to choose a quantity.

In general, a cook station app may preferably implement at least the following functions:
Item queuing for Fryer, Rethermalizer, Rehydration, Reheating
Rethermalizer timer and tracking
Data capture for analytics & notifications
Remote updates

Rethermalizer Now Reheating Area. Referring again to FIG. 6, the “Now Reheating” area 610 on the left side of the display shows what ingredients are currently in the Rethermalizer and their status. (Preferably, the arrangement of different elements on the screen display is configurable.) Ingredient status is also sent to the Production Line app so production line workers can see what ingredients will be available and how soon. In one embodiment, touching an ingredient tile in the Next Up area 616 opens an ingredient popup that allows for cancelling the job or changing the quantity. This queue is a stack—new ingredients appear at the bottom (left to right) and ingredients move up as other ingredients are removed. Hold timers do not begin until the “Transfer To Hot Cabinet” button is touched in the ingredient popup.

The retherm and fryer queues may display a tile or other icon for each ingredient item in the queue. In an embodiment, a tile background or main color may indicate a category of the item. State such as “cooking” or “draining” or “cooling” may be among the states indicated on the tiles in these queues. The current timer value is displayed. The particular states may vary according to the ingredient item and the cooking or preparation process (workflow) being applied. Large type font messages may request actions such as “Transfer”—when an item has completed rethermalization. A hold timer starts after the ingredient is transferred into bins. The system, as noted, should indicate batch numbers or letters (i.e. batch codes) for tracking each batch. Batch codes may be sequentially assigned so that the relative age of a batch (oldest to newest) can be identified by the assigned batch code. Each different ingredient may have a different ordered list of batch codes. A user my label the bins accordingly or “pre-tagged” bins may be used (for example, bar coded, RFID, etc.). Digital fingerprinting can be used to enable a sensor (for example, a camera) to uniquely identify a specific bin or pan with no label on it at all. The bins may be placed into a production area or backup holding area. Human-readable visible labels are preferred (for now) to support users managing ingredients manually.

In general, the ability to coordinate and queue steps of multiple back-of-house processes in a central and automated fashion may reduce or eliminate the need for employee training or re-training. For example, a user interface adapted to instruct workers on a task-by-task basis, monitor worker performance, and provide immediate corrective feedback where necessary, means that a new employee may be able to contribute immediately. It is presently disclosed that the certainty and clarity of the training, the reduction in mental effort or stress in learning new processes (e.g. ingredients, recipes, food-handling guidelines, etc.) and/or the aesthetics of a well-designed interface may increase employee satisfaction, reduce a store's turnover rate, and provide access to a larger employee pool.

In some embodiments, coordination of one or more items of equipment or workflow processes may enable automatic systems to replace some manual labor. As a non-limiting example, by tracking demand, inventory, temperature, and history of ingredients, some embodiments may move an ingredient from a freezer to a rethermalizer automatically at a time calculated to minimize waste, while maintaining a reasonable certainty that there will not be a shortage before the ingredient is ready. Some embodiments may also allow for the anticipation of shortages and provide instructions and/or modify recipes in order to stretch ingredients (e.g. provide less per standard portion so as not to run out).

In some embodiments, information about ingredients, equipment, employees, or other physical elements may be obtained through sensors. Sensors can include any device capable of characterizing and/or converting attributes of the physical world into data. Without limitation, sensors in some embodiments may include cameras (e.g. optical cameras, infrared cameras, UV cameras, and/or cameras capable of detecting and capturing or imaging any wavelength or wavelengths of light, and/or depth cameras), thermometers, accelerometers, magnetometers, pressure sensors, scales, vibration sensors, motion sensors, wireless networking devices, RFID readers, microphones, chronometers, calorimeters, barometers, hygrometers, hydrometers, etc. Sensors may, in some embodiments, be embedded within equipment, worn, or located elsewhere. Equipment, ingredients, employees, and other physical objects may have identifiers to facilitate detection and/or identification by sensors. Such identifiers may include, without limitation, RFID tags, barcodes, QR codes, or other devices or images affixed, embedded, attached, or otherwise associated with the person or object to which each is associated.

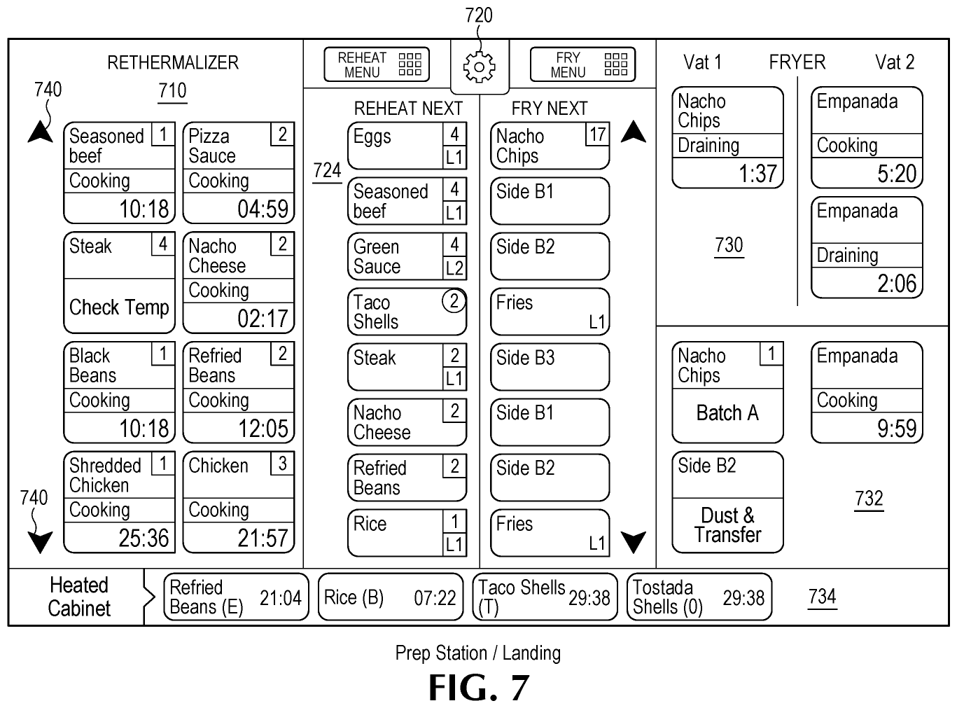

FIG. 7 shows another example of a prep station (client app) main screen or “landing screen.” Prep Station app is part of a connected production line system. In an embodiment, it may provide one or more of the following functions:
1. Manage reheating ingredients in the Rethermalizer and tracking their hold times.
2. Manage frying, draining, shaking, and cooling ingredients in both connected and non-connected fryers.
3. Automatically assign batch codes to ingredients.
4. Manage fried ingredients that are batched, e.g.: multiple fry jobs end up in the same batch with the same batch code.
5. Configurability to swap which queue is on which side of the screen to support physical store layouts.
6. Support transfer of completed ingredients and their hold times to the Heated Cabinet.
7. Support transfer of rehydrated and warmed ingredients to the Heated Cabinet.
8. Accept requests for ingredients from the Production Line app.
9. Allow manual start of a job by picking an ingredient from a menu.
10. Allow manual setting of ingredient quantity in the Rethermalizer menu or from an ingredient popup.
11. Send ingredient status to the Production Line app.

In this example interactive screen display, the following display areas are shown on the prep/cook main screen. This example is merely illustrative; other embodiments may employ fewer or additional areas:
Rethermalizing In Progress: This area 710 shows the ingredients actively cooking in the rethermalizer.
Queues: Items either requested from a production line or manually chosen from the reheat and fry menus are queued here in “Reheat Next” area 724.
Settings: The Settings button 720 accesses the app settings screen for changing properties like swapping the rethermalizer/fryer screen sides, etc.
Frying In Progress: Ingredients actively frying are shown here in area 730. For connected fryers, this area shows the vats (Vat1, Vat 2) and all data comes from the fryer as cooks are started there. Of course this area is only used in systems that have a fryer or similar equipment.
Multipurpose Area: This area 732 holds both batched fried ingredients and ingredients that are cooling.
Heated Cabinet Summary Bar: This bar 734 shows the status of the four ingredients that are prepped by putting them in the Heated Cabinet: Refried Beans, Rice, Taco Shells, & Tostada Shells. The full Heated Cabinet can be accessed by touching the Heated Cabinet button on the left.
Arrows For Scrolling: The rethermalizing in progress area and the reheat and fryer queues may have arrows 740 to scroll their lists if there are too many ingredients to fit on the screen. If there are no off-screen ingredients the arrows may be grayed out.

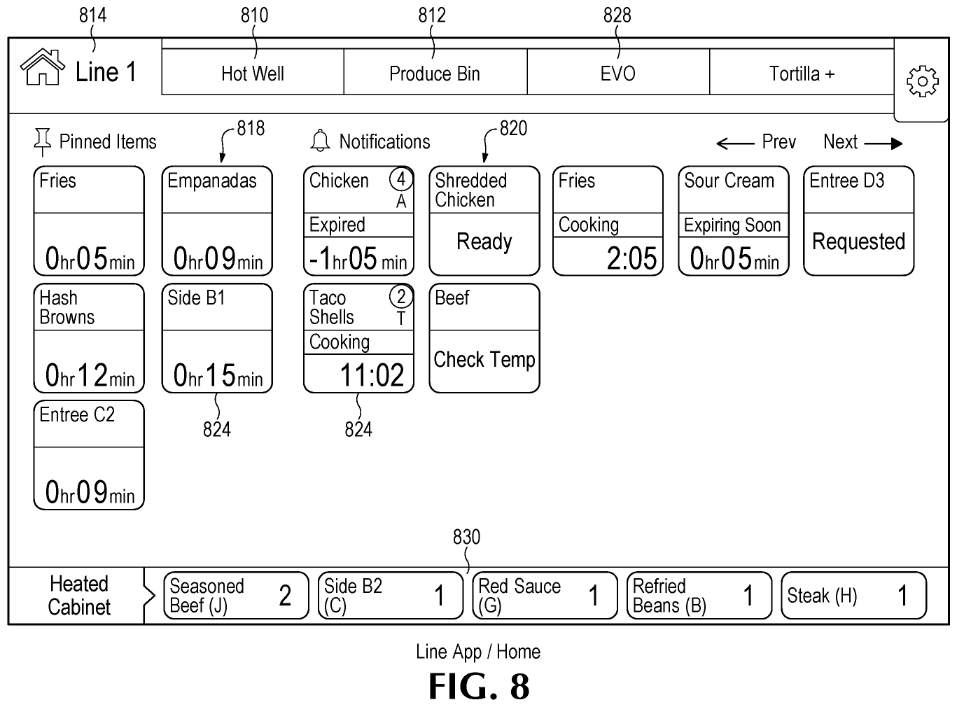

FIG. 8 is an illustration of an example of a production line app home screen display. The home screen or landing screen may include a default or main display image with tabs 810, 812 or another user interface element, to access additional display pages, or images. The main screen should identify its production area location 814, for example, “Line 1” or “Front Counter.” The main screen preferably has one region 818 for pinned ingredient items, and a second region 820 for display of Notifications. As illustrated, both the pinned items and the notifications may be displayed as tiles on the main page, for example, tiles 824, wherein each tile comprise a name of the item, and additional information such as state or status (“cooking” “ready” etc.), and if applicable, timer value (time remaining to expiration). Colors may be used in background to identify item categories (per the ingredient parameters). Pinned items are those commonly used items selected to remain “pinned” to the main page until removed. These are items with relatively fast turnover that therefore require frequent attention.

The additional display pages, or different images, accessed by visual tabs, may correspond to item current physical locations such as hot well, product bin, warming cabinet (“EVO” 828), etc. Other special areas may be added, such as specially warmed or cooled containers. A special display element 830, preferably along the bottom of the main page, may show a some of the ingredients currently in an area (say heated cabinet), so that these ingredients are always visible, or at least some of them, even when the heated cabinet tab is not selected. Choosing the heated cabinet tab will display a heated cabinet page showing all of the ingredients there located. For each tabbed area, the corresponding screen display page shows a tile for each ingredient located in that area, each tile indicating a current state and current timer value for the corresponding ingredient.

The Notifications field 820 shows tiles for ingredients that require attention, for example, because a hold timer for that item has expired. The tile may flash on and off until acknowledged (for example, touched). An audible alarm may be used. If the home screen tab is not the active tab (so the Notification is not visible), a special flashing alert may be displayed on or above the current tab page, calling attention to check the home screen. The timer may be configured to continue counting down (into “negative time”) to show the time elapsed since the initial timer period expired.

In some embodiments, timers, alerts, requests, or statutes may be generated, initiated, stopped, and/or cancelled by users and/or automatically started based on the occurrence of business events and/or data obtained from sensors. In some embodiments, the authority to user permissions, time restrictions, and/or other rules may determine when functionality is available to users and/or when automated actions can be performed by the broker or a user application. As an example, in some embodiments a user interface allows a user to discard an item, send an item back to a production line, reheat an item, and/or discard an item. In some embodiments, user selections in the user interface will be automatically affected in the physical environment by relevant equipment through control by a broker and/or user application. In some embodiments, user selections in the user interface will update the state of a virtual object, and initiate additional user output and/or user input to guide users in completing the physical task. As an example, in some embodiments a user input indicating that an ingredient should be discarded may initiate instructions to direct equipment to move the physical item into a disposal receptacle, may initiate user instructions to discard the item, may request user feedback indicating that the task has been completed, and/or may confirm that the task has been completed by analyzing relevant sensor data (e.g. scales in the garbage receptacle, computer vision systems, etc.).

For ingredients that have a pan wash time that is different from the ingredient's hold time, the pan wash time will need to be tracked separately, with separate notifications and a mechanism to acknowledge that the pan has been washed. The disclosed system is easily configured to implement this feature and washing other items besides pans as may be required.

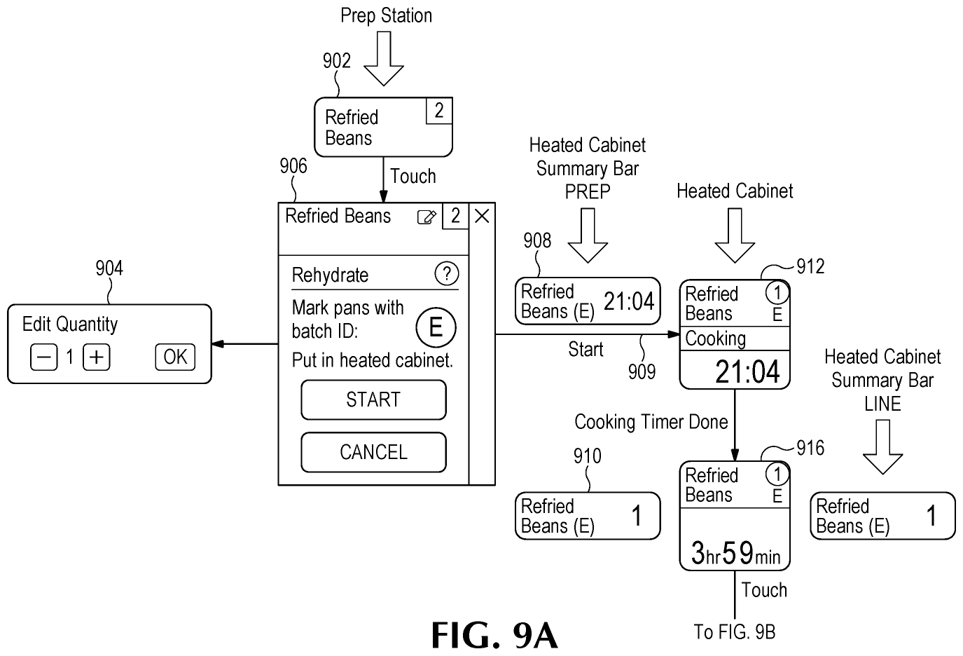

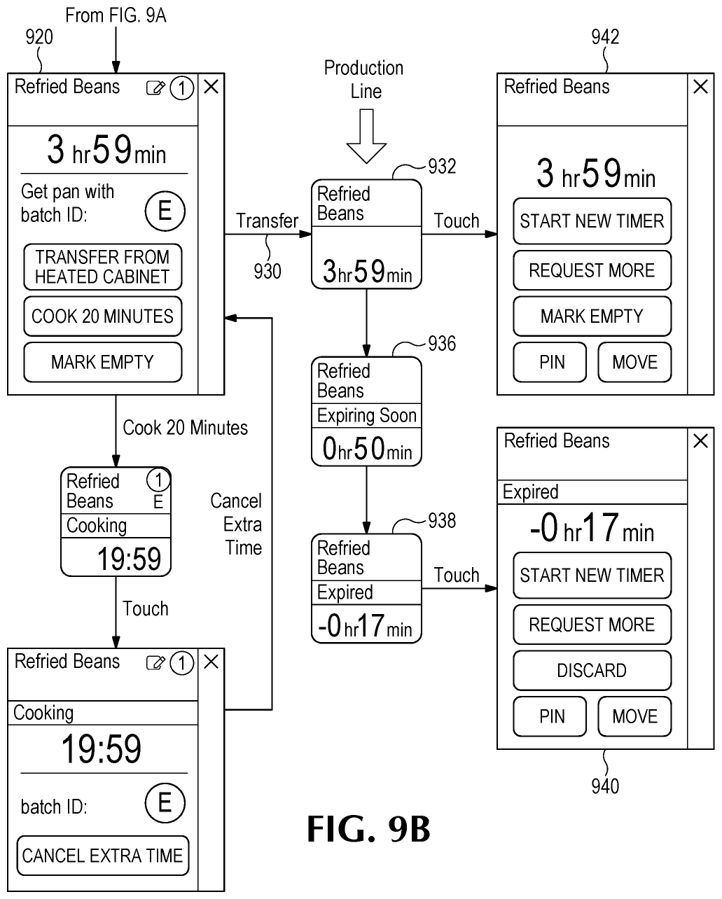

FIG. 9 is an example of a workflow for managing a specific ingredient. This is an example of an item, namely refried beans, that is “cooked” in a heated cabinet at the prep station, and then transferred to a production line when ready. This figure shows the workflow logic executed by a processor during operation (in one embodiment, the logic flow is implemented by an orchestrator client), and it also shows representative screen display tiles and messages that may be triggered by inputs and state changes, such as manual input at a user interface (touching a tile in a touchscreen, for example) or state changes such as the start or expiration of a timer. Various inputs can be manual or machine-generated. The various inputs and screen display outputs can be communicated via a central hub, although other networking architectures and protocols can be used. In one embodiment, MQTT (Message Queuing Telemetry Transport) can be utilized to implement a publish-subscribe-based messaging protocol. MQTT works on top of the TCP/IP protocol.

FIGS. 9A and 9B together represent a workflow example. The workflow advances temporally from the top left generally toward the bottom right. The displayed states, timer values, etc. reflect the corresponding values (for example, variables) maintained in the corresponding software processes. For example, the first column shows the prep station display where a user has selected the tile 902 representing refried beans. Touching the tile asserts a request, and triggers a panel or pop-up 906, which may enable the user to select a quantity (non-zero integer number of units, for example), panel 904. Panel 906 instructs the user to mark a pan with batch number E and put the pan in the heated cabinet. When this is done, the user presses the start button, path 909, to start “cooking” the refried beans. That input 909 triggers the start of a cooking timer which is then displayed in a tile 912 in the heated cabinet display panel. (In the earlier illustrations, the heated cabinet display may be a page or tab in a prep area display.) The tile 912 preferably identifies the ingredient (Refried beans), the state (Cooking), the number of pans or units (1), the batch number or code (E), and the time remaining on the cooking timer (21:04 remaining).

The timer runs until expiration (“cooking timer done”) which triggers a state change reflected in tile 916 (no longer cooking). Additionally, the timer expiration may trigger an alarm or notification as discussed earlier. When a user touches the tile 916 a new panel or pop-up 920 is displayed giving the user one or more options represented by respective “buttons,” such as transfer or mark empty. For example, tile 910 appears in the heated cabinet summary bar, the user may “claim” the pan of beans for use at a production line by pressing the tile in the user interface. Or more cooking may be selected. Assuming the user touches the transfer button, path 930 advances the workflow to display a tile 932 in the production line client display, identifying the item and the hold time remaining (3 hr:59 min).

The hold timer continues to run down until it reaches a predetermined “expiring soon” value—here 50 minutes. This triggers a pop-up or a notification on the tile, indicating the state Expiring Soon; see tile update 936. The expiring soon value (time remaining amount) may be a function of the preparation time of the item. It may be specified in the corresponding ingredient stored parameters. The timer continues to count down until it expires.

This expiration triggers a state change to “Expired” which is reflected in the tile update at 938. The counter may continue counting down to indicate the time elapsed since expiration, as shown in tile 938 (timer value −0 hr 17 min). When a user touches the tile 938, it triggers a panel 940 which may present one or more options, such as “start new timer,” request more (of the ingredient), or “discard.” In another scenario, a user may touch the tile 932 before the “Expiring Soon” time is reached. For example, the production line may see unusual demand for the ingredient or a backlog of orders that require the ingredient, and the current batch is running low. This input (touch) triggers a panel 942 presenting options similar to panel 940, but it does not indicate Expired and shows the remaining hold time. The user may touch one or more buttons to indicate “Request More” or “Mark Empty” or “Start New Timer.” The Request More option is an example of a manual ingredient request, which may initiate a new instance of the same workflow at panel 906 described above. Various different workflows may be fashioned along similar lines, to automatically implement various parameters including those reflected in individual ingredient parameters, and or storewide policies, to ensure quality and food safety, while minimizing the employee training demands.

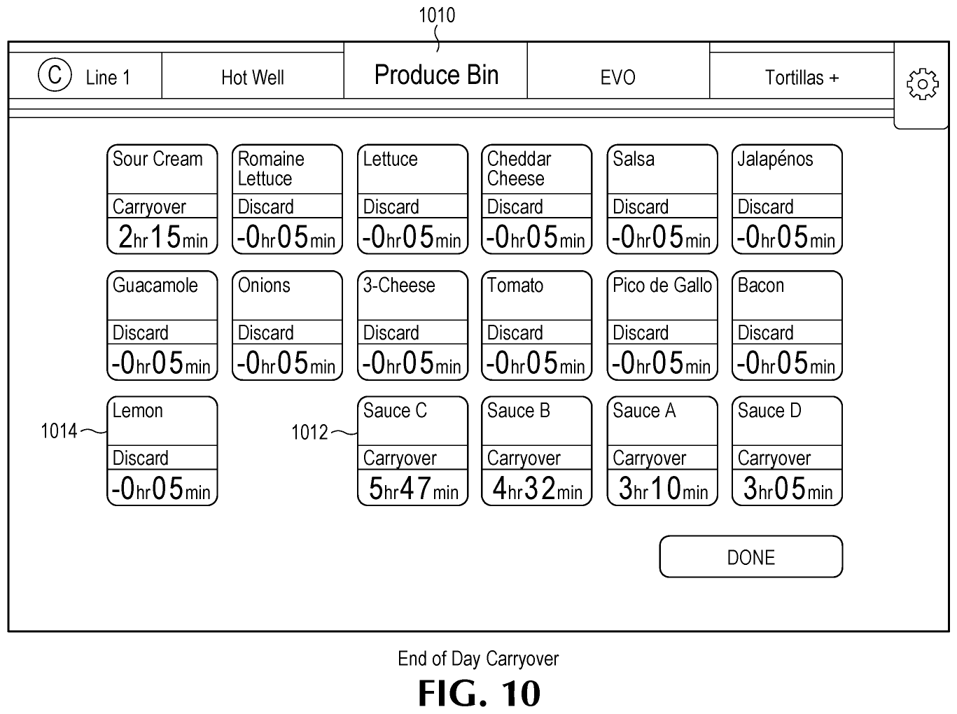

As another example, workflows can be used to properly manage ingredient carry-over policies and parameters. FIG. 10 is an example of an end-of-day carry over screen display. Here, the Produce Bin tab 1010 is selected. Carryover implementation for the other tabs may be implemented in similar fashion. Tiles are displayed for all of the items currently located in the produce bin, for example, tiles 1012, 1014, according to their states stored in memory. For each item (ingredient), the tile indicates Carryover or Discard. Color may be used to add clarity in the display; for example, green for carryover and red for discard. The hold times remaining are shown as well. The hold times have expired for the items marked discard. Carryover policies may be specified in the respective ingredient stored parameters. In an embodiment, the parameters may specify which ingredients qualify for carryover at all. They may specify a minimum remaining hold time to qualify for carryover. In the illustration of FIG. 10, only sour cream and four sauces are indicated for carryover; the other produce bin items are discarded at the end of the day in this example.

### Hardware and Software

Most of the equipment discussed above comprises hardware and associated software. For example, the typical electronic device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

One of skill in the art will recognize that the concepts taught herein can be tailored to a particular application in many other ways. In particular, those skilled in the art will recognize that the illustrated examples are but one of many alternative implementations that will become apparent upon reading this disclosure. It will be obvious to those having skill in the art that many changes may be made to the details of the above-described embodiments without departing from the underlying principles of the invention. The scope of the present invention should, therefore, be determined only by the following claims.

1. A commercial kitchen control system comprising:
a receiver configured to receive status information from a connected kitchen appliance;
a memory storing data defining a plurality of workflows, including a first workflow defining a set of work processes that utilize the connected kitchen appliance to cook/prep an ingredient, the set of work processes comprising a first work process and a second work process;
a user interface to provide image display output and receive user input;
a processor operatively coupled to the user interface and configured to, in operation:
select and begin executing the first workflow in response to an input to the user interface;
initialize a first work process timer associated with the first work process;
display a first current value of the first work process timer on the user interface as a first time elapsed or a first time remaining;
display a notification to the user interface prompting a user to perform the first work process based on the received status information from the connected kitchen appliance and the first workflow;
initialize a second work process timer associated with the second work process; and
display a second current value of the second work process timer on the user interface as a second time elapsed or a second time remaining.

2. The system of claim 1 wherein the processor is configured to generate an image for display in the user interface, and the image is divided into a first display area and a second display area, the first display area corresponding to one or more of the connected kitchen appliances, and the first display area identifying an ingredient currently located in the connected kitchen appliance and showing an ingredient work process timer associated with the ingredient currently located in the connected kitchen appliance, the ingredient work process timer being the first work process timer or the second work process timer.

3. The system of claim 1 wherein the processor is configured to generate an image for display in the user interface, and the image is divided into a plurality of display areas and each display area is arranged to display one or more information tiles, each information tile identifying an ingredient in use and its current physical location in the commercial kitchen, and at least one of the information tiles showing the first work process timer or the second work process timer.

4. The system of claim 3 wherein the processor is further configured to assign a batch code to each new batch of an particular ingredient introduced into the system, wherein the batch codes are sequentially assigned so that the relative age of a batch (oldest to newest) can be identified by the assigned batch code, while a different ingredient has a different ordered list of batch codes, and wherein at least some of the information tiles include an indication of the corresponding batch code.

5. The system of claim 3 wherein the processor is further configured to detect an ingredient hold timer nearing expiration and generate an audible and or visual indication in the screen display that the hold timer is nearing expiration, the ingredient hold timer being the first work process timer or the second work process timer.

6. The system of claim 1 wherein the processor is configured to generate an image for display in the user interface, the image including an area corresponding to a prep/cook station that includes one or more tiles respectively corresponding to one or more ingredients located in the prep/cook area, a tile of the one or more tiles indicating a corresponding ingredient name, a current state of its corresponding ingredient, and a current value of a timer for its corresponding ingredient, at least one of the tiles of the one or more tiles having the first work process timer or the second work process timer as the timer for its corresponding ingredient.

7. The system of claim 6 wherein the processor is further configured to display an instruction panel in or over a particular tile of the one or more tiles to instruct user action for the particular tile's corresponding ingredient responsive to the timer for the particular tile's corresponding ingredient expiring.

8. The system of claim 1 wherein the processor is configured to generate a first image for display in the user interface, the first image corresponding to a production station that includes one or more tiles respectively corresponding to one or more ingredients associated with the production station, a particular tile of the one or more tiles having a color indicative of a category of its corresponding ingredient, the image also including one or more user interface (UI) elements respectively corresponding to one or more physical locations of the production station; and
the processor further configured to display a second image in response to a selection of a particular UI element of the one or more UI elements corresponding to a particular physical location of the particular tile's corresponding ingredient, the second image including an area representing the particular physical location showing the particular tile, the one or more physical locations including the particular location.

9. The system of claim 1 wherein the processor is further configured to:
maintain in the memory respective current states and locations of two or more ingredients currently in the system, including a particular current state and a particular location of a particular ingredient of the two or more ingredients;
in response to a change in the particular current state of the particular ingredient, preform the initialization of the first work process timer;
in response to an expiration of the first work process timer, perform the display of the notification prompting the user to perform the first work process;
receive an indication of completion of the first work process from the user interface; and
in response to the received indication, perform the initialization of the second work process timer and update the particular current state and the particular location of the particular ingredient.

10. The system of claim 9 wherein the processor is further configured to:
maintain in the memory respective current states and locations of two or more ingredients currently in the system, including a particular current state and a particular location of a particular ingredient of the two or more ingredients;
in response to an expiration of the second work process timer, perform the display of the notification prompting the user to perform the first work process;
receive an indication of completion of the first work process from the user interface; and
in response to the received indication, perform the initialization of the first work process timer and update the particular current state and the particular location of the particular ingredient.

11. The system of claim 3 further comprising a fryer state machine application coupled to the processor, wherein the processor is further configured to:
based on the received status information, track a number of uses of the connected kitchen appliance since a last oil change in the fryer state machine, the connected kitchen appliance comprising a connected fryer; and
responsive to the number of uses exceeding a limit, generate a user interface display message to change cooking oil of the fryer.

12. A system comprising:
a production client comprising a first interactive user interface located in a production area of a kitchen;
a preparation/cook client comprising a second interactive user interface located in a preparation area of the kitchen;
a connected kitchen appliance;
an orchestrator;
a broker arranged to provide communications among the production client, the preparation client, the connected kitchen appliance, and the orchestrator; and
a database coupled to the orchestrator for storing a plurality of workflows and a plurality of ingredient parameters;
wherein the orchestrator is configured to select and execute one or more of the plurality of workflows responsive to inputs received via the broker to manage the preparation and holding of an ingredient to maintain quality and safety of the ingredient based on at least one ingredient parameter associated with the ingredient, the plurality of ingredient parameters comprising the at least one ingredient parameter;
the production client, the preparation/cook client, the orchestrator, the broker, and the database comprising respective applications, the respective applications arranged to execute on one or more digital devices comprising one or more processors and coupled to the first interactive user interface, the second interactive user interface, and the connected kitchen appliance.

13. The system of claim 12 wherein the connected kitchen appliance is a cooking equipment, and the cooking equipment is arranged to transmit state data to the broker.

14. The system of claim 12 including a connected kitchen appliance state machine application, coupled to the broker and arranged to maintain a virtual state machine responsive to state data provided by the connected kitchen appliance.

15. The system of claim 12 wherein the orchestrator is arranged to dynamically maintain in memory, indicia of a location, a state and a timer value of one or more ingredients in use in the kitchen.

16. The system of claim 15 wherein the location of a particular ingredient of the one or more ingredients comprises the preparation area, the production location, or a backup area of the kitchen.

17. The system of claim 16 wherein the location of the particular ingredient further comprises a hot well, a produce bin, or a heated cabinet.

18. The system of claim 12 wherein the preparation/cook client generates for the second interactive user interface a screen display that shows a tile for an ingredient located in the preparation area and indicating a current state and current timer value for the ingredient.

19. The system of claim 12 wherein the production client is configured to generate, for display on the first interactive user interface, a screen display that includes a home screen divided into at least a first zone showing a pinned tile corresponding to a first ingredient identified as a high volume item, and a second zone showing a notification associated with a second ingredient.

20. The system of claim 19 wherein the home screen includes tabs for display of ingredient items according to their respective locations in the production area.

21. The system of claim 12 wherein the preparation/cook application, responsive to a timer expiration, is configured to:
generate a screen display for the second interactive user interface displaying a message requesting a user action, wherein the action is determined by a workflow of the plurality of workflows;
receive an indication of a user action from the second interactive user interface; and
in response to the received indication, update a status and a location of an ingredient and initiate a timer based on the workflow.

22. The system of claim 12 wherein the orchestrator application is arranged to, responsive to an expiration of a state timer, commencing a new timer to track a time elapsed since the state timer expiration, and cancel the new timer in response to a user input that indicates an action was taken on an ingredient associated with the new timer.

23. The system of claim 12 wherein:
the broker comprises an MQTT server; and
the production client, the preparation/cook client, and the orchestrator comprise respective MQTT clients arranged for communications with the MQTT server.

24. The system of claim 12 wherein the orchestrator's respective application causes the orchestrator, in operation, to:
receive a request for more of the ingredient;
select and begin executing a particular workflow of the plurality of workflows corresponding to the request;
publish a message to the preparation client to request an action to begin preparation of a new batch of the ingredient according to the particular workflow;
assign a batch code to the new batch of the ingredient;
start a prep timer responsive to receiving an indication that the requested action was taken to begin the preparation of the ingredient;
update in memory a prep timer value, a state, and a location associated with the new batch of the ingredient;
update at least one of a set of user interface displays to indicate the updated prep timer value, the updated state, and the updated location associated with the new batch of the ingredient, the set of user interface display comprising the first interactive user interface display and the second interactive user interface display; and
perform at least one other task as indicated by the particular workflow.

25. The system of claim 24 wherein the orchestrator is further arranged to:
in response to an expiration of the prep timer, cause instructions to be shown on the second interactive user interface to mark a bin containing the new batch of the ingredient with the assigned batch code and transfer the bin to a specified location;
responsive to receiving an indication that the instructed transfer was completed, update in memory the state and location associated with the new batch of the ingredient; and
starting a hold time timer for the new batch of the ingredient.

26. The system of claim 12 wherein the orchestrator is further arranged to:
cause the display, in the kitchen, of an image including an elements corresponding to the ingredients indicating whether to discard or carry over the ingredient based a hold timer the at least one ingredient parameter.

27. The system of claim 26 wherein the orchestrator is further arranged to:
responsive to receiving user interface inputs indicating whether the ingredient has been discarded or carried over, update in memory state data associated with the ingredient.

28. A method for a commercial kitchen comprising the steps of:
storing a set of workflows associated with a plurality of ingredients be used in a production area of the commercial kitchen to make menu items;
storing a plurality of ingredient parameters, a particular ingredient parameter of the plurality of ingredient parameters associated with an ingredient of the plurality of ingredients and including an ingredient name, a category, a hold time, or a preparation time;
selecting a workflow of the set of workflows, the workflow associated with the particular ingredient; and
executing the workflow based on the particular ingredient parameter; wherein
executing the selected workflow includes initializing and operating a software timer based on the particular ingredient parameter, the particular ingredient parameter comprising the hold time or the preparation time; and
executing the workflow includes display of a current value of the software timer on a user interface.

29. The method of claim 28 wherein a second ingredient parameter of the plurality of ingredient parameters includes an eligibility for carryover, a time remaining before carryover will not be allowed, a cook time, or a drain time.

30. The method of claim 28 wherein a second ingredient parameter of the plurality of ingredient parameters includes a cool time, an auto-request status, or whether the ingredient is eligible to be stored in a hot cabinet.

31. The method of claim 28 wherein executing the workflow includes:
displaying a user instruction on the user interface;
receiving an input from the user interface; and
advancing a state of the workflow in response to the input from the user interface.
